(19) United States
(12) Patent Application Publication
(10) Pub. No.: US 2024/0137509 A1
(43) Pub. Date: Apr. 25, 2024

(54) GEOMETRIC AFFINE MODE AND GEOMETRIC SUBBLOCK MODES

(71) Applicant: Tencent America LLC, Palo Alto, CA (US)

(72) Inventors: Xin ZHAO, San Jose, CA (US); Guichun LI, San Jose, CA (US); Han GAO, San Diego, CA (US); Lien-Fei CHEN, Hsinchu (TW); Shan LIU, San Jose, CA (US)

(73) Assignee: Tencent America LLC, Palo Alto, CA (US)

(21) Appl. No.: 18/379,613

(22) Filed: Oct. 12, 2023

Related U.S. Application Data
(60) Provisional application No. 63/416,404, filed on Oct. 14, 2022.

(51) Int. Cl. H04N 19/119; H04N 19/139; H04N 19/159; H04N 19/176

(52) U.S. Cl. CPC H04N 19/119; H04N 19/139; H04N 19/159; H04N 19/176

(57) ABSTRACT

Aspects of the disclosure include methods and apparatuses for video encoding/decoding. In some examples, an apparatus for video decoding includes processing circuitry. The processing circuitry receives, from a coded video bitstream, coded information associated with a current block in a current picture. The coded information indicates that the current block is coded in a geometric partition mode (GPM), the current block is partitioned into at least a first partition and a second partition in the GPM by a partition edge. The processing circuitry determines that at least the first partition is coded in a subblock motion mode. The first partition includes a plurality of subblocks. The processing circuitry determines a plurality of motion vectors for the plurality of subblocks in the first partition of the current block, and reconstructs the plurality of subblocks in the first partition of the current block according to the plurality of motion vectors respectively.

### INCORPORATION BY REFERENCE

The present application claims the benefit of priority to U.S. Provisional Application No. 63/416,404, “Geometric affine mode and geometric subblock modes” filed on Oct. 14, 2022, which is incorporated by reference herein in its entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding. In some examples, an apparatus for video decoding includes processing circuitry. The processing circuitry receives, from a coded video bitstream, coded information associated with a current block in a current picture. The coded information indicates that the current block is coded in a geometric partition mode (GPM), the current block is partitioned into at least a first partition and a second partition in the GPM by a partition edge. The partition edge is a line that intersects with boundaries of the current block. The processing circuitry determines that at least the first partition is coded in a subblock motion mode. The first partition includes a plurality of subblocks. The processing circuitry determines a plurality of motion vectors for the plurality of subblocks in the first partition of the current block, and reconstructs the plurality of subblocks in the first partition of the current block according to the plurality of motion vectors respectively.

The subblock motion mode refers to prediction of the plurality of subblocks using motion information at the subblock level. In some examples, the subblock motion mode includes at least one of an affine prediction mode, a subblock based temporal motion vector prediction (SbTMVP), and a subblock based decoder side motion vector refinement (DMVR).

To determine that at least the first partition is coded in the subblock motion mode, in some examples, the processing circuitry decodes, in response to the current block in the GPM, a flag from the coded video bitstream, the flag indicates that both of the first partition and the second partition are in the subblock motion mode. In another example, the processing circuitry determines that the first partition is coded in a merge mode, and in response to the first partition in the merge mode, decodes a flag from the coded video bitstream, the flag indicates whether the first partition is in a regular merge mode or a subblock based merge mode. In another example, the processing circuitry determines that the first partition is coded in an advanced motion vector prediction (AMVP) mode, and in response to the first partition in the AMVP mode, decodes a flag from the coded video bitstream, the flag indicating whether the first partition is in a regular AMVP mode or an affine AMVP mode.

In some examples, the subblock motion mode is an affine mode, and the processing circuitry determines that the first partition and the second partition are coded in the affine mode, determines a first affine model for the first partition and a second affine model for the second partition, and reconstructs the first partition of the current block according to the first affine model and the second partition of the current block according to the second affine model.

In an example, the partition edge intersects with a top block boundary of the current block and does not intersect with a left block boundary of the current block, first control points for the first partition are located at a top-left corner, a top-right corner and a bottom-left corner of the first partition, and second control points for the second partition are located at a top-left corner, a top-right corner and a bottom-left corner of the second partition.

In an example, the partition edge intersects with a left block boundary of the current block and does not intersect with a top block boundary of the current block, first control points for the first partition are located at a top-left corner, and a bottom-left corner of the first partition, and second control points for the second partition are located at a top-left corner, a top-right corner and a bottom-left corner of the second partition.

In an example, the partition edge intersects with both a left block boundary of the current block and a top block boundary of the current block, first control points for the first partition are located at a top-left corner, a top-right corner and a bottom-left corner of the first partition, and second control points for the second partition are located at a top-left corner, a top-right corner and a bottom-left corner of the second partition.

In some examples, the subblock motion mode is an affine mode, the partition edge intersects none of a left block boundary of the current block and a top block boundary of the current block, first control points for the first partition are located at a top-left corner, a top-right corner and a bottom-left corner of the first partition, and the affine mode is not allowed for the second partition.

In some examples, the subblock motion mode is an affine mode, the processing circuitry derives a first affine model for the first partition, and a second affine model for the second partition based on control points of the current block, the first affine model is different from the second affine model. In an example, the processing circuitry derives control point motion vectors for the first partition from an affine model of a first affine merge candidate of the current block, and derives control point motion vectors for the second partition from an affine model of a second affine merge candidate of the current block.

In some examples, the processing circuitry determines a control point motion vector at a corner of the first partition from one of a plurality of translational motion vector candidates at the corner, the plurality of translational motion vector candidates include at least one of motion vectors associated with spatial neighboring blocks or motion vectors associated with temporal neighboring blocks.

In some examples, the subblock motion mode is a subblock based temporal motion vector prediction (SbTMVP). The processing circuitry determines, in a collocated picture of the current picture, a reference geometric partition for the first partition, the reference geometric partition having a same shape as the first partition, and applies a plurality of subblock motions of the reference geometric partition to the plurality of subblocks of the first partition.

In some examples, the processing circuitry determines a displacement vector that points to the reference geometric partition from a motion vector of a neighboring block of the current block. In some examples, the processing circuitry determines a displacement vector that points to the reference geometric partition based on a motion vector of a neighboring block of the current block and a motion vector difference. In an example, the processing circuitry decodes the motion vector difference from the coded video bitstream. In another example, the processing circuitry derives the motion vector difference using template matching.

In some examples, for a motion vector refinement on a motion vector of the first partition, the processing circuitry determines a first reference region in a first reference picture, the first reference region has a same shape as the first partition, and determines a second reference region in a second reference picture, the second reference region has the same shape as the first partition. The processing circuitry calculates a matching cost associated with the motion vector refinement using the first reference region and the second reference region and performs a decoder side motion vector refinement according to the matching cost associated with the motion vector refinement.

In some examples, for a motion vector refinement on a motion vector of the first partition, the processing circuitry determines a first reference block in a first reference picture, the first reference block has a same shape as the current block, determines a second reference block in a second reference picture, the second reference block has the same shape as the current block. The processing circuitry calculates a matching cost associated with the motion vector refinement using the first reference block and the second reference block and performs a decoder side motion vector refinement according to the matching cost associated with the motion vector refinement.

In some examples, the subblock motion mode is a subblock based decoder side motion vector refinement (DMVR), and the processing circuitry refines the motion vectors for the plurality of subblocks in the first partition of the current block using the subblock based DMVR.

Aspects of the disclosure also provide a non-transitory computer-readable medium storing instructions which, when executed by a computer, cause the computer to perform the method for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary block diagram of a decoder.

FIG. 3 is a schematic illustration of an exemplary block diagram of an encoder.

FIG. 4 shows a diagram of angles that are used in a geometric partition mode (GPM) in some examples.

FIG. 5 shows a diagram of possible partition edges for the angle index 3 in an example.

FIG. 6 shows a diagram that illustrates the blending process in some examples.

FIGS. 7A-7B show diagrams of blocks with affine motion field in some examples.

FIG. 8 shows a diagram for deriving motion vectors of subblocks in a block in some examples.

FIGS. 9A-9C show diagrams of blocks in the GPM in some examples.

FIG. 10 shows a diagram of a block in the GPM in some examples.

FIG. 11 shows a diagram of a block in the GPM in some examples.

FIG. 12 shows a diagram of a block in the GPM in some examples.

FIG. 13 shows a block in the GPM to illustrate construction of affine model in some examples.

FIG. 14 shows a block in the GPM to illustrate construction of affine model in some examples.

FIG. 15 shows a diagram having a block in the GPM to illustrate construction of affine model in some examples.

FIG. 16 shows a diagram having a block (1610) in the GPM in some examples.

FIG. 17 shows a flow chart outlining a process according to some embodiments of the disclosure.

FIG. 18 shows a flow chart outlining a process according to some embodiments of the disclosure.

FIG. 19 is a schematic illustration of a computer system in accordance with an embodiment.

### DETAILED DESCRIPTION OF EMBODIMENTS

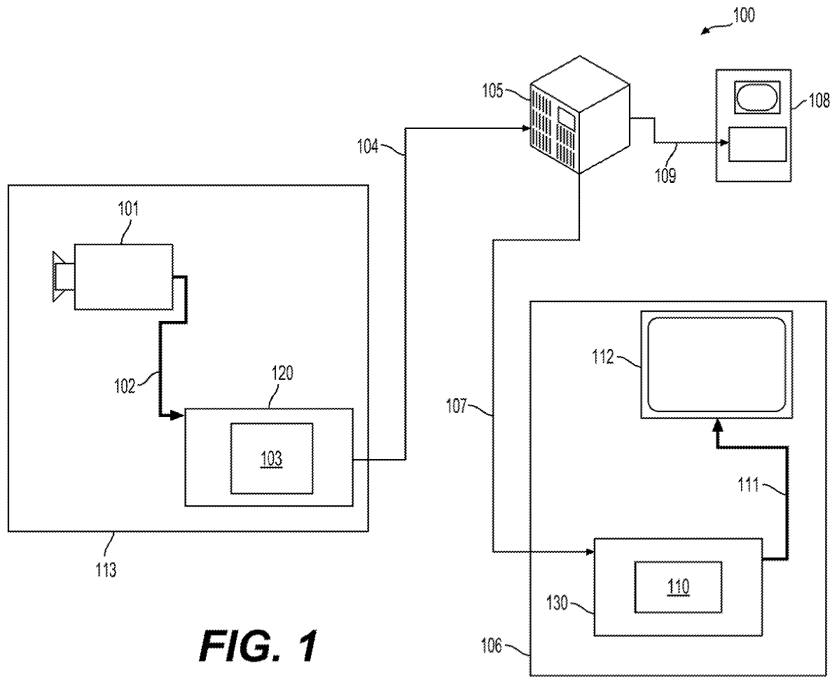

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

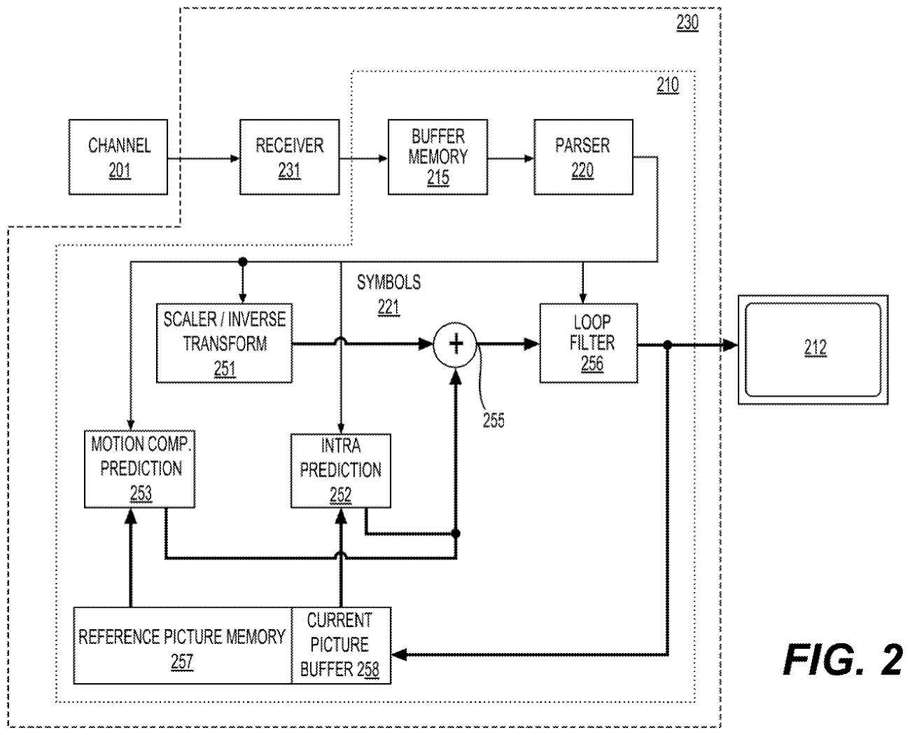

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an embodiment, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

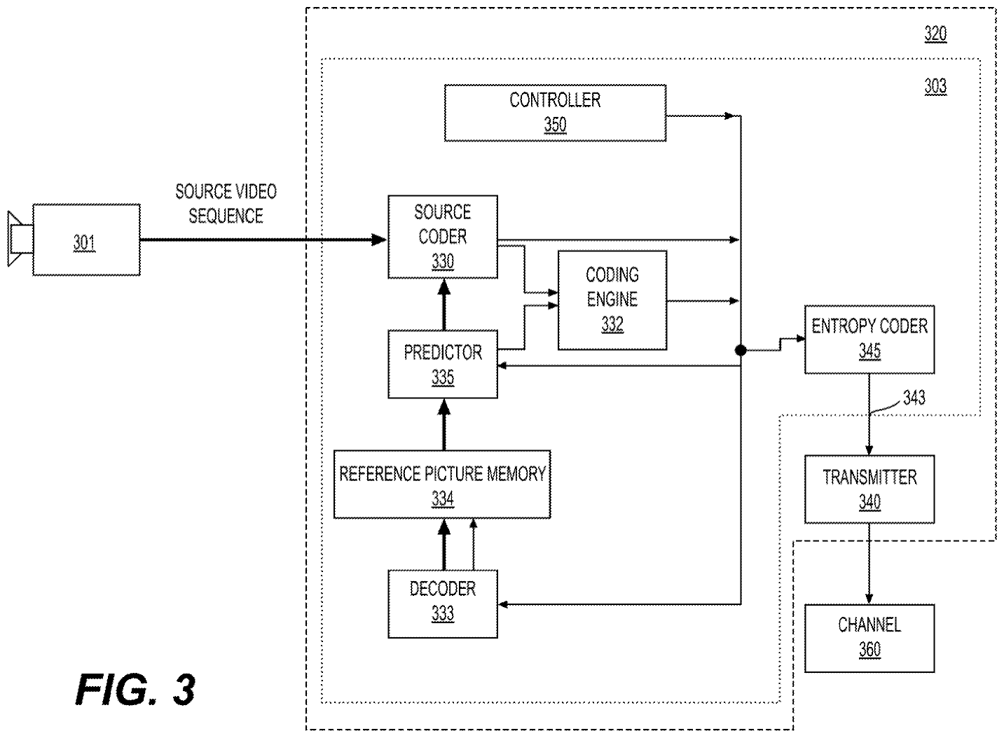

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an embodiment, the video encoder (303) may code and compress the pictures of the source video sequence into a coded video sequence (343) in real time or under any other time constraints as required. Enforcing appropriate coding speed is one function of a controller (350). In some embodiments, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some embodiments, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an embodiment, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an embodiment, the video encoders (103) and (303) and the video decoders (110) and (210) can be implemented using one or more integrated circuits. In another embodiment, the video encoders (103) and (303), and the video decoders (110) and (210) can be implemented using one or more processors that execute software instructions.

Aspects of the disclosure provide techniques for applying subblock motion modes on top of a geometric partition; more specifically, applying subblock motion modes on one or more partitions of a block in geometric partition mode (GPM).

In an example, an affine mode is applied on one or more partitions of a block in the GPM, and the coding mode of the one or more partitions can be referred to as geometric affine mode. In another example, a subblock motion mode, such as a subblock-based temporal motion vector prediction (SbTMVP), a subblock based decoder side motion vector refinement (DMVR), an affine mode (also referred to as affine prediction mode) and the like, is applied on one or more partitions of a block in the GPM, and the coding mode of the one or more partitions can be referred to as geometric subblock mode. The GPM and the affine mode will be further described in the present disclosure.

In some examples (e.g., VVC), a technique that is referred to as geometric partition mode (GPM) is used. Specifically, in VVC, GPM is used for inter prediction. In an example, the GPM is only applied to CUs that are 8×8 or larger. The GPM can be signaled using a CU-level flag as one kind of merge modes, with other merge modes, such as a regular merge mode, a merge with motion vector difference (MMVD) mode, a combined inter and intra prediction (CIIP) mode and a subblock merge mode.

When the GPM mode is used on a CU, the CU is split by a partition edge into two geometric-shaped partitions using one of a plurality of partitioning manners. In some examples, 64 different partitioning manners are used. The partitioning manners can be differentiated by 24 angles (non-uniformed quantized between 0 and 360°) and up to 4 edges relative to the center of the CU for each angle. The partition edge is a line that intersects boundaries of the CU and splits the CU into two partitions.

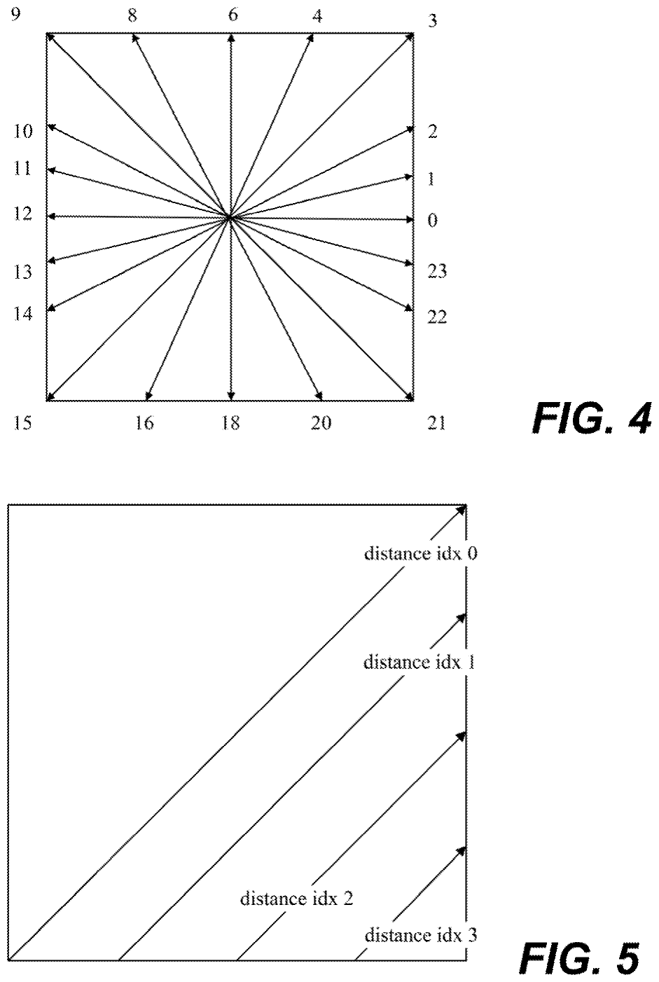

FIG. 4 shows a diagram of 24 angles that are used in the GPM in some examples. The angles can be identified using angle indices, such as angle index 0 to angle index 23 in some examples.

FIG. 5 shows a diagram of possible partition edges for the angle index 3 in an example. In FIG. 5, four possible partition edges can be associated with the angle index 3. It is noted that, for some angle indices, three possible partition edges may be associated with each angle index.

In some examples, each geometric partition in the CU is inter-predicted using its own motion. In an example, only uni-prediction is allowed for each partition, that is, each partition has one motion vector and one reference picture index. The uni-prediction motion constraint is applied to ensure that, similar to bi-prediction, two motion compensated predictions are needed for each CU.

In some examples, when the GPM is used for the current CU, then a signal indicating the geometric partition index (e.g., indicating an angle and an edge), and two merge indices (one for each partition) are further signalled. In an example, the number of maximum GPM candidate size is signalled explicitly at slice level and specifies syntax binarization for GPM merge indices.

In some examples, after predicting each of these two geometric partitions, the sample values along the geometric partition edge are adjusted using a blending process with adaptive weights.

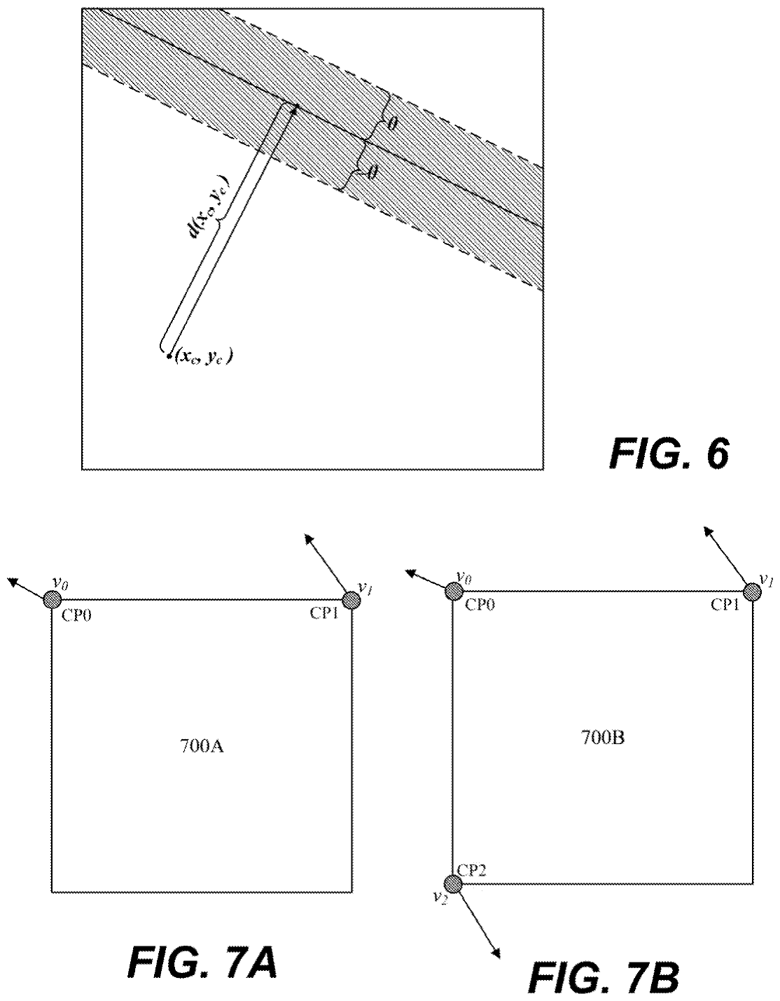

FIG. 6 shows a diagram that illustrates the blending process in some examples. The blending process uses a parameter that is referred to as a blending strength or blending area width θ of GPM. The blending strength θ can be fixed for all different contents.

In some examples, weighing values in a blending mask for the blending process can be given by a ramp function, such as according to Eq. (1)

$${ω}_{{r}_{c} , {y}_{c}} = \{ \begin{matrix}0 & d ( {x}_{c} , {y}_{c} ) \leq - θ \\ \frac{8}{20} ( d ( {x}_{c} , {y}_{c} ) + θ ) & - θ < d ( {x}_{c} , {y}_{c} ) < θ \\ 8 & d ( {x}_{c} , {y}_{c} ) \geq θ ,\end{matrix} \qquad Eq . ( 1 )$$

In an example, with a fixed θ=2 pel, the ramp function can be quantized as

ω_{m,n}=Clip3(0,8,(d(m,n)+32+4)>>3)

The result of the blending process is used as the prediction signal for the whole CU, and transform and quantization process can be further applied to the whole CU in a similar manner as in other prediction modes. Finally, the motion field (e.g., motion information) of the CU predicted using the GPM is stored. In some examples (e.g., VVC), the motion information of a CU is stored in 4×4 unit (e.g., for every 4×4 luma samples). The stored motion information is used for the MV prediction and merge list construction for next coded CU. In GPM, three types of motion information are spanned and stored in 4×4 unit. The three types of motion information may include motion information of the two partitions, and motion information of the blending area. For example, two geometric partitions, P₀ and P₁, include their own unidirectional MV and the blending area between P₀ and P₁ is predicted by motion information from the two geometric partitions, P₀ and P₁. Therefore, the motion information of GPM is stored according to the partitions.

The motion information of GPM is signaled at merge mode. In order to avoid additional memory bandwidth access, only uni-prediction is allowed for each partition in the GPM. In some examples, the regular merge candidates may be a uni-prediction or bi-prediction and cannot be directly used as GPM merge list. In order to minimize the implementation complexity, an index parity-based method can be used to directly extract the GPM merge candidates from the regular merge list without pruning. For example, for a candidate with an even value of the GPM merge index, the MV0 from reference list 0 with its corresponding regular merge index is used as the GPM merge candidate. If MV0 is not available, MV1 from reference list 1 is used instead. Conversely, MV1 is chosen as the default GPM merge candidate for the odd value of the GPM merge index.

In some examples, a technique that is referred to as affine motion compensated prediction (or affine mode) can be used. In HEVC, only translation motion model is applied for motion compensation prediction (MCP). While in the real world, there are many kinds of motions, such as zoom in/out, rotation, perspective motions and the other irregular motions. In some examples (e.g., VTM), a block-based affine transform motion compensation prediction is applied.

FIG. 7A shows a diagram of a block (700A) with an affine motion field described by motion information of two control points CP0 and CP1; FIG. 7B shows a diagram of a block (700B) with an affine motion field described by motion information of three control points CP0, CP1 and CP2. The two control points in FIG. 7A can provide motion information for a 4-parameter affine model. The three control points in FIG. 7B can provide motion information for a 6-parameter affine model.

In some examples, for 4-parameter affine motion model, motion vector at sample location (x, y) in a block is derived as Eq. (2)

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = - \frac{{mv}_{1 y} - {mv}_{0 y}}{W} x + \frac{{mv}_{1 x} - {mv}_{0 x}}{W} y + {mv}_{0 y}\end{matrix} \qquad Eq . ( 2 )$$

The 4-parameter affine motion model can also be described as Eq. (3):

$$\{ \begin{matrix}{mv}_{x} = ax + by + c \\ {mv}_{y} = - bx + ay + f\end{matrix} \qquad Eq . ( 3 )$$

In some examples, for 6-parameter affine motion model, motion vector at sample location (x, y) in a block is derived as Eq. (4):

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = - \frac{{mv}_{1 y} - {mv}_{0 y}}{W} x + \frac{{mv}_{2 y} - {mv}_{0 y}}{H} y + {mv}_{0 y}\end{matrix} \qquad Eq . ( 4 )$$

The 6-parameter affine model can also be described as Eq. (5):

$$\{ \begin{matrix}{mv}_{x} = ax + by + c \\ {mv}_{y} = dx + ey + f\end{matrix} \qquad Eq . ( 5 )$$

In Eq. (2) and Eq. (3), (mv₀ₓ, mv_{0y}) is motion vector of the top-left corner control point (shown as CP0), (mv₁ₓ, mv_{1y}) is motion vector of the top-right corner control point (shown as CP1), and (mv₂ₓ, mv_{2y}) is motion vector of the bottom-left corner control point (shown as CP2).

In some examples, in order to simplify the motion compensation prediction, block based affine transform prediction is applied.

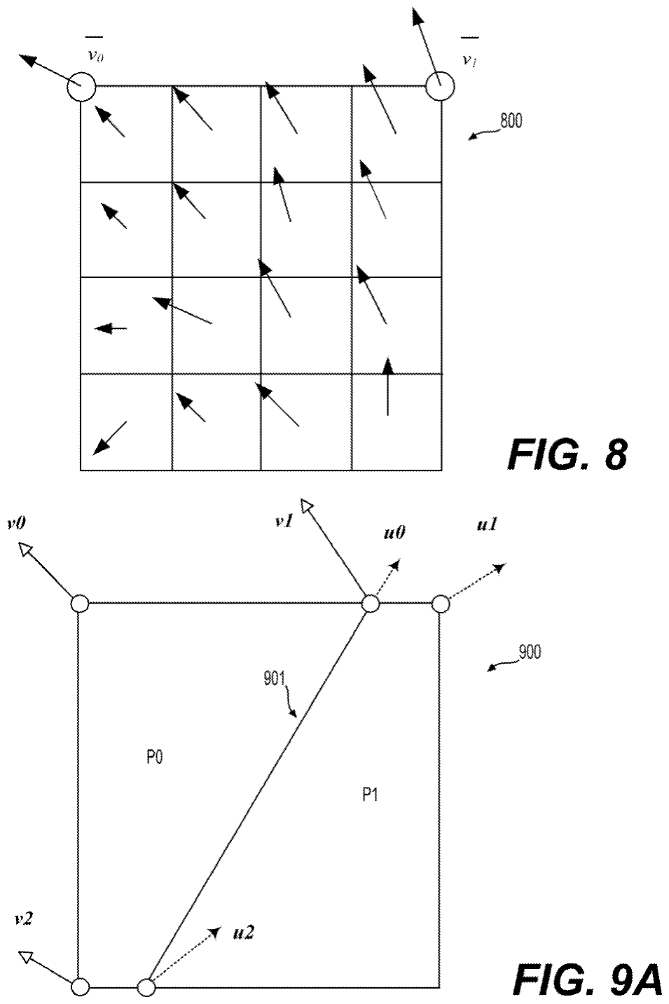

FIG. 8 shows a diagram for deriving motion vector of each 4×4 luma sub-block in a block (800) in some examples. As shown in FIG. 8, each small square represents a 4×4 luma sub-block. The motion vector of the center sample of each sub-block is calculated according to, for example Eq. (2)-Eq. (5), and rounded to 1/16 fraction accuracy. Then, the motion compensation interpolation filters are applied to generate the prediction of each sub-block with the derived motion vector. The sub-block size of chroma-components is also set to be 4×4. The MV of a 4×4 chroma sub-block is calculated as the average of the MVs of the four corresponding 4×4 luma sub-blocks in an example.

For inter prediction with translation motion, there are two inter prediction modes that are referred to as merge mode and advanced motion vector prediction (AMVP) mode. In the merge mode, the motion vector is derived from neighboring blocks and is directly used for motion compensation. In the AMVP mode, the motion vector is represented with motion vector predictor and a difference. Similarly, for inter prediction with affine motion, there are two inter prediction modes that are referred to as affine merge mode and affine AMVP mode. In the affine merge mode, motion information of spatial neighbor blocks is used to generate CPMVs for the current block. In the affine AMVP mode, the differences between vectors of current block and the predictors can be signaled in the coded video bitstream, CPMV can be represented by the predictions and the differences.

It is noted that affine mode is a kind of subblock based motion compensation modes. Some other subblock based motion compensation modes can be used in video coding.

In some examples (e.g., VVC), the subblock-based temporal motion vector prediction (SbTMVP) is used. SbTMVP uses the motion field in the collocated picture to improve motion vector prediction and merge mode for CUs in the current picture. SbTMVP can use the same collocated picture used by TMVP. SbTMVP differs from TMVP in two main aspects. In the first aspect, TMVP predicts motion at CU level but SbTMVP predicts motion at sub-CU level. In the second aspect, TMVP fetches the temporal motion vectors from the collocated block in the collocated picture, SbTMVP applies a motion shift before fetching the temporal motion information from the collocated picture, and the motion shift is obtained from the motion vector from one of the spatial neighboring blocks of the current CU.

In some examples, the subblock based decoder side motion vector refinement (DMVR). DMVR is a bilateral-matching (BM) based decoder side motion vector refinement. In bi-prediction operation, a refined MV is searched around the initial MVs in the reference picture list L0 and reference picture list L1. The BM method calculates the distortion between the two candidate blocks in the reference picture list L0 and list L1. In an example, sum of absolute differences (SAD) between a block pair (in two reference pictures) based on each MV candidate around the initial MV is calculated. The MV candidate with the lowest SAD becomes the refined MV and is used to generate the bi-predicted signal. The subblock DMVR can perform BM by subblocks in the current block.

In some related examples (e.g., VVC and ECM), affine motion model cannot be used for a geometric partition. The geometric partitions can only use translational motion model, Aspects of the disclosure provide techniques to use affine motion model for one or more geometric partitions, thus affine prediction mode can be used for the one or more geometry partitions, and can improve coding performance. In some examples, zoom in, zoom out, or rotation motion of an object on a same background can be performed. GPM can be used to code the edge portion between the object and the background. For example, a block can be partitioned into a first partition on the object side, and a second partition on the background side. Using affine motion model for first partition on the object side can improve the coding quality of the object.

It is noted that various techniques in the present disclosure may be used separately or combined in any order. While GPM is used in the following description to illustrate the techniques, the techniques can be applied to GPM, or variant of GPM, such as wedge based prediction mode as defined in AV1, or a geometric coding block partition.

According to an aspect of the disclosure, subblock motion modes can be applied on top of a geometric partition of a block in the GPM. In some examples, a block in the GPM is partitioned into at least a first partition (also referred to as first geometric partition) and a second partition (second geometric partition) by a partition edge (also referred to as geometric partition boundary). In some examples, the first partition includes a plurality of subblocks, encoder/decoder can determine a plurality of motion vectors for the plurality of subblocks in the first partition of the block, and reconstruct the plurality of subblocks in the first partition of the block according to the plurality of motion vectors respectively.

A subblock motion mode refers to using fine-granular motion information at subblock level for prediction. For example, in a subblock motion mode, a CU is partitioned into subblocks, and each subblock is predicted based on motion information of the subblock at the subblock level. The subblock motion modes include but not limited to affine prediction mode, subblock TMVP, subblock DMVR and the like. When a subblock mode is applied on a geometric partition of a block in the GPM, the coding mode of the geometric partition is referred to as a geometric subblock mode. In an example, when the affine mode is applied on a geometric partition of a block in the GPM, the coding mode of the geometric partition is referred to as a geometric affine mode.

In some embodiments, a geometric subblock flag (e.g., a flag indicative of geometric subblock mode) is signaled when geometric partition is applied to the current block, the geometric subblock flag can indicate that both partitions or at least one of the two partitions are coded using subblock prediction mode (e.g., affine predication and the like). In an example, even when both geometric partitions are coded by affine prediction, the affine model for each geometric partition can be different.

In some embodiments, when a geometric partition uses merge mode, a flag is signaled to indicate whether this geometric partition uses a regular merge mode, or a subblock based merge mode. For example, the flag being a first value (e.g., 0) indicates the regular merge mode is applied on the geometric partition, and the flag being a second value (e.g., 1) indicates the subblock based merge mode is applied on the geometric partition.

In some embodiments, when a geometric partition uses AMVP mode, a flag is signaled to indicate whether affine AMVP mode is applied for the geometric partition. For example, the flag being a first value (e.g., 0) indicates the regular AMVP mode is applied on the geometric partition, and the flag being a second value (e.g., 1) indicates the affine AMVP mode is applied on the geometric partition.

In some embodiments, when applying affine motion model for a geometric partition, the control point locations can depend on the partition boundary (e.g., also referred to as partition edge). In some examples, the control point locations (locations of the control points) are suitably shifted to their neighboring locations (left, top, right, bottom). The geometric partitions are respectively predicted based on respective control points.

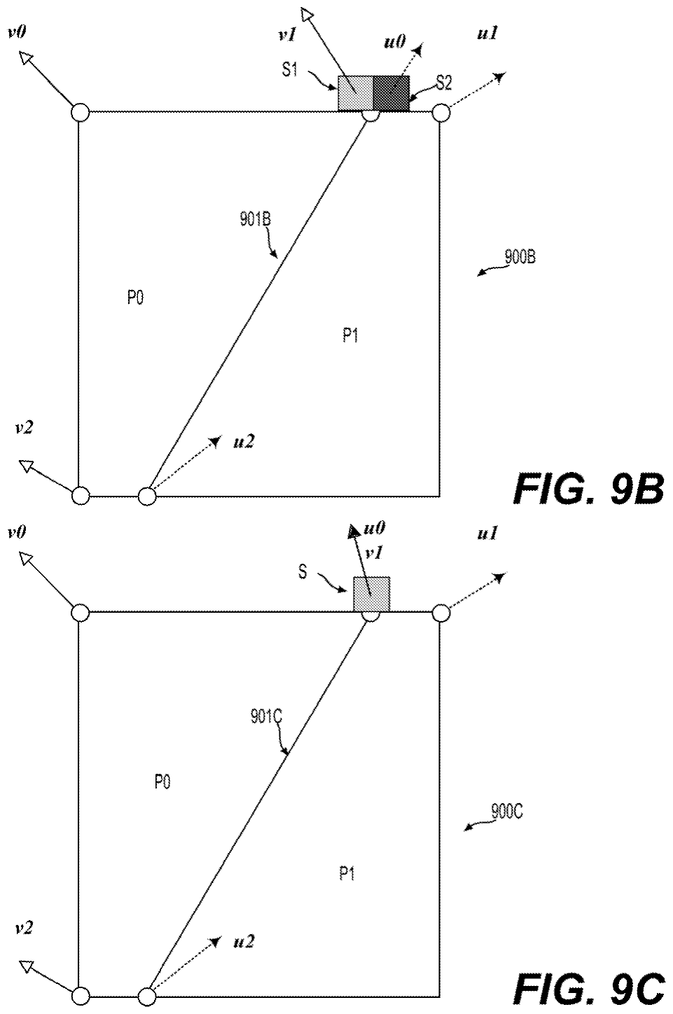

FIG. 9A shows a diagram of a block (900) in the GPM in some examples. The block (900) is partitioned by a partition edge (901) into a first partition P0 and a second partition P1. The first partition P0 is also referred to as left partition, and the second partition P1 is also referred to as right partition in FIG. 9A example. The partition edge (901) is also referred to as geometric partition boundary (901).

In the FIG. 9A example, the geometric partition boundary (901) intersects with the top block boundary of the block (900), the control points for left partition P0 are located at the top-left (shown with MV v0), top-right (shown with MV v1), and bottom-left (shown with MV v2) of left partition P0, and the control points for right partition P1 are located at the top-left (shown with MV u0), top-right (shown with MV u1) and bottom-left (shown with MV u2) of right partition P1. The motion vectors of the control points are suitably determined based on motion information of the neighboring locations. It is noted that, in an example, the control point at bottom-left (shown with MV u2) of right partition P1 is not available. In another example, the control point at bottom-left (shown with MV u2) of right partition P1 is determined based on the left partition P0 after the left partition P0 is reconstructed.

It is noted that the motion vector v1 and the motion vector u0 can be different or can be the same.

FIG. 9B shows a diagram of a block (900B) in the GPM in some examples. Similar to FIG. 9A, the block (900B) is partitioned by a partition edge (901B) into a first partition P0 and a second partition P1. In the FIG. 9B example, the partition edge (901B) intersects the top block boundary between two 4×4 units S1 and S2. In an example, the motion vector v1 is determined based on the motion information at the center of S1, and the motion vector u0 is determined based on the motion information at the center of S2.

FIG. 9C shows a diagram of a block (900C) in the GPM in some examples. Similar to FIG. 9A, the block (900C) is partitioned by a partition edge (901C) into a first partition P0 and a second partition P1. In the FIG. 9C example, the partition edge (901B) intersects the top block boundary at a position in a 4×4 unit S. In an example, the motion vector v1 and the motion vector u0 are determined based on the motion information at the center of S, and can be the same.

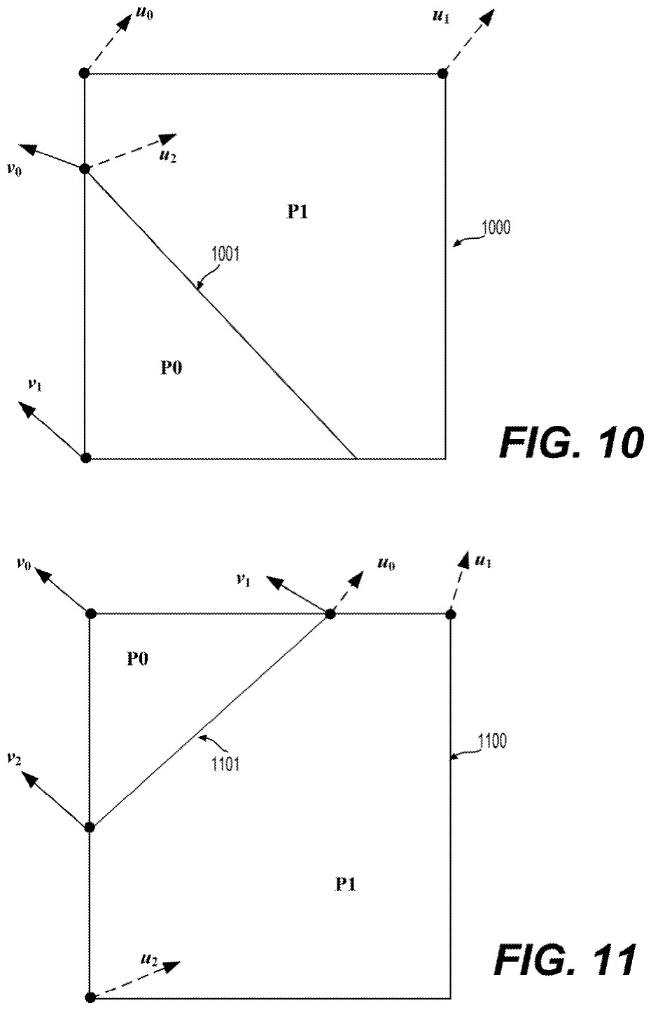

FIG. 10 shows a diagram of a block (1000) in the GPM in some examples. The block (1000) is partitioned by a partition edge (1001) into a first partition P0 and a second partition P1. The first partition P0 is also referred to as left partition, and the second partition P1 is also referred to as right partition in FIG. 10 example. The partition edge (1001) is also referred to as geometric partition boundary (1001).

In the FIG. 10 example, the geometric partition boundary (1001) intersects with the left block boundary, the control points for left partition P0 are located at the top-left (shown with MV v0), and bottom-left (shown with MV v1) of first partition P0, and the control points for right partition (P1) are located at the top-left (shown with MV u0), top-right (shown with MV u1) and bottom-left (shown with MV u2) of second partition P1.

FIG. 11 shows a diagram of a block (1100) in the GPM in some examples. The block (1100) is partitioned by a partition edge (1101) into a first partition P0 and a second partition P1. The first partition P0 is also referred to as left partition, and the second partition P1 is also referred to as right partition in FIG. 11 example. The partition edge (1101) is also referred to as geometric partition boundary (1101).

In the FIG. 11 example, the geometric partition boundary (1101) intersects with both the left block boundary and the top block boundary, the control points for left partition P0 are located at the top-left (shown with MV v0), top-right (shown with MV v1) and bottom-left (shown with MV v2) of the left partition P0, and the control points for right partition P1 are located at the top-left (shown with MV u0), top-right (shown with MV u1) and bottom-left (shown with MV u2) of right partition P1.

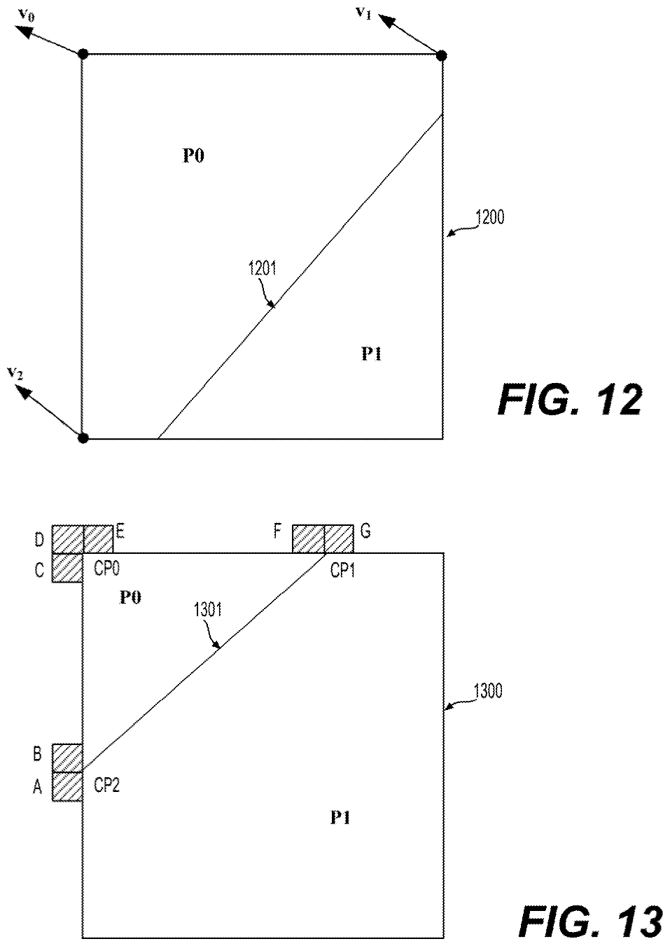

FIG. 12 shows a diagram of a block (1200) in the GPM in some examples. The block (1200) is partitioned by a partition edge (1201) into a first partition P0 and a second partition P1. The first partition P0 is also referred to as top-left partition, and the second partition P1 is also referred to as bottom-right partition in FIG. 12 example. The partition edge (1201) is also referred to as geometric partition boundary (1201).

In some examples, such as in the FIG. 12 example, the geometric partition boundary (1201) intersects none of the left block boundary or the top block boundary of the block (1200), the control points for top-left partition (P0) are located at the top-left (shown with MV v0), top-right (shown with MV v1) and bottom-left (shown with MV v2) of the top left partition P0. In an example, the bottom right partition P1 does not allow affine mode and related signaling can be skipped.

In some examples, such as in the FIG. 12 example, the geometric partition boundary (1201) intersects none of the left block boundary or the top block boundary of the block (1200), the control points for both partitions (P0 and P1) are located at the top-left (shown with MV v0), top-right (shown with MV v1) and bottom-left (shown with MV v2) of the block (1200), the set of CPMVs for each partition may be different between the partitions, e.g. derived separately for each partition based on affine merge candidates or affine AMVP for geometric partitions. In an example, the control points for the first partition P0 and the second partition P1 are derived based on different affine merge candidates. In another example, the control points for the first partition P0 and the second partition P1 are derived based on different affine AMVP. In another example, the control points for the first partition P0 and the second partition P1 are derived based on different affine models, such as 4-parameter model, 6-parameter model and the like.

In some examples, the control point motion vectors of a geometric partition are derived from affine model of an affine merge candidate. The affine merge candidate can be derived from the existing subblock merge candidate list, or derived separately based on the position of the geometric partition and its neighboring (spatial or temporal) blocks (including affine coded blocks and/or blocks with translational motion), non-adjacent blocks, or previously affine coded blocks. The derivation can use affine model inheritance from affine models; the derivation can also use the method of constructed affine models based on translational motion information of spatial or temporal neighboring blocks of each control point.

In some embodiments, when using constructed affine method, each CPMV may have multiple translational MV candidates, such as multiple spatial or temporal neighboring blocks.

FIG. 13 shows a block (1300) in the GPM to illustrate construction of affine model in some examples. The block (1300) is partitioned by a partition edge (1301) into a first partition P0 and a second partition P1. The first partition P0 is also referred to as left partition, and the second partition P1 is also referred to as right partition in FIG. 13 example. The partition edge (1301) is also referred to as geometric partition boundary (1301).

In the FIG. 13 example, one from the two or three blocks located at each corner of the left partition P0 can be selected as the CPMV associated with the corner position. For example, blocks A and B are 4×4 subblocks at the bottom left corner of the left partition P0, blocks C, D and E are 4×4 subblocks at the top left corner of the left partition P0, and blocks F and G are 4×4 subblocks at the top right corner of the left partition P0. One from the blocks A and B can be selected to derive the CPMV of CP2, one from the blocks C, D and E can be selected to derive the CPMV of CP0, and one from the blocks F and G can be selected to derive the CPMV of CP1.

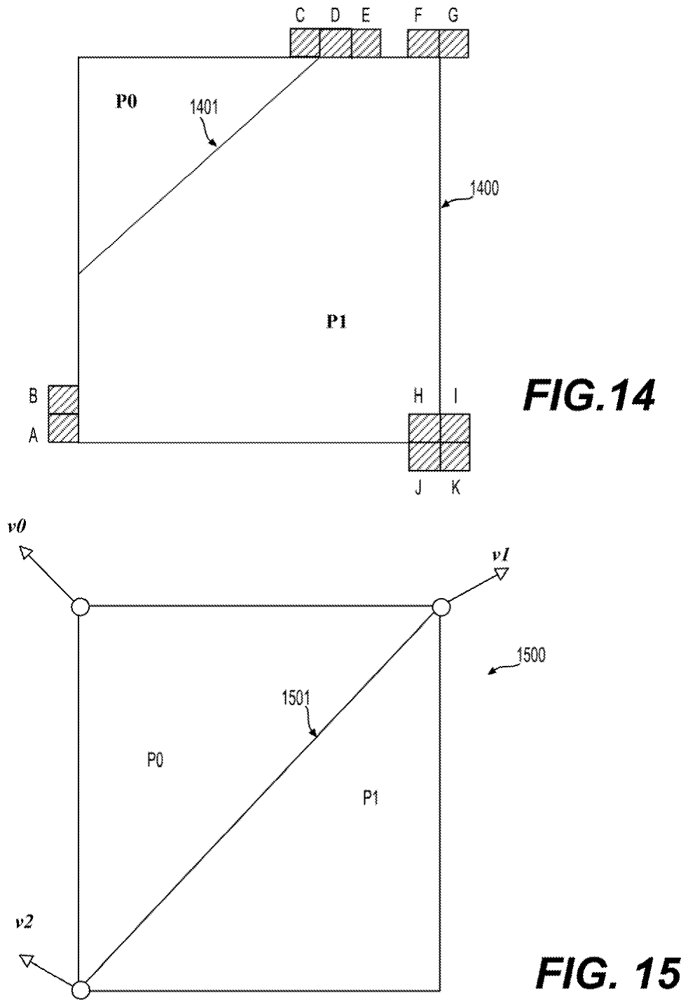

FIG. 14 shows a block (1400) in the GPM to illustrate construction of affine model in some examples. The block (1400) is partitioned by a partition edge (1401) into a first partition P0 and a second partition P1. The first partition P0 is also referred to as left partition, and the second partition P1 is also referred to as right partition in FIG. 14 example. The partition edge (1401) is also referred to as geometric partition boundary (1401).

For the right partition P1, one from multiple blocks located at each corner of the right partition P1 can be selected as the CPMV associated with the corner position, while the bottom rights blocks come from the temporal neighboring block. For example, blocks A and B are 4×4 subblocks at the bottom left corner of the right partition P1, blocks C, D and E are 4×4 subblocks at the top left corner of the right partition P1, and blocks F and G are 4×4 subblocks at the top right corner of the right partition P1. One from the blocks A and B can be selected to derive the CPMV of the bottom left corner, one from the blocks C, D and E can be selected to derive the CPMV of top left corner, and one from the blocks F and G can be selected to derive the CPMV of top right. Blocks H, I, J and K are collocated 4×4 subblocks at a collocated picture for the current picture, and are temporal neighboring blocks. In an example, one from the blocks H, I, J and K can be selected to derive the CPMV of the bottom right corner of the block (1400).

In some embodiments, both geometric partitions of a current block have control points at the corners of current block before splitting, similar to the affine control points for regular coding blocks. For example, the partition edge is a diagonal line of the current block.

FIG. 15 shows a block (1500) in the GPM to illustrate construction of affine model in some examples. The block (1500) is partitioned by a partition edge (1501) into a first partition P0 and a second partition P1. The first partition P0 is also referred to as left partition, and the second partition P1 is also referred to as right partition in FIG. 15 example. The partition edge (1501) is also referred to as geometric partition boundary (1501). The partition edge (1501) is a diagonal line of the block (1500). In an example, a set of CPMVs for each partition may be different between the geometric partitions, e.g., derived separately for each partition based on affine merge candidates for geometric partitions.

In some embodiments, subblock based SbTMVP can be applied. For example, for each geometric partition, another region with the same shape as current geometric partition is identified in the co-located picture (also collocated picture), the region is referred to as reference geometric partition. Then, the subblock motions, such as motion vectors are fetched from the identified reference geometric partition and applied for each subblock of current geometric partition for applying motion compensation.

In some examples, the reference geometric partition is identified using a displacement vector that can be either derived using neighboring block motion vectors, or neighboring block motion vector plus a motion vector difference that can be signaled, or derived using template matching. In an example, the displacement vector that points to the reference geometric partition in the collocated picture is derived using neighboring block motion vectors. In another example, the displacement vector that points to the reference geometric partition is determined as a combination of a neighboring block motion vector and a motion vector difference. The motion vector difference can be signaled or can be derived using template matching.

In some examples, the reference geometric partition is identified using a displacement vector that is derived from a history-based merge candidates (e.g., history-based motion vector prediction (HMVP) candidates).

In some examples, the reference geometric partition is identified using a displacement vector that is signaled based on MV predictor and MV difference, similar to MV signaling in AMVP process.

According to an aspect of the disclosure, for a geometric partition, when bi-prediction is allowed, the motion vector of the geometric partition can be further refined using DMVR in some examples.

In some embodiments, when DMVR is applied on a geometric partition, the DMVR matching cost is calculated using a forward reference region (in a first reference picture that is prior to the current picture) with the same geometric partition shape and a backward reference region (in a second reference picture that is after the current picture) with the same geometric partition shape.

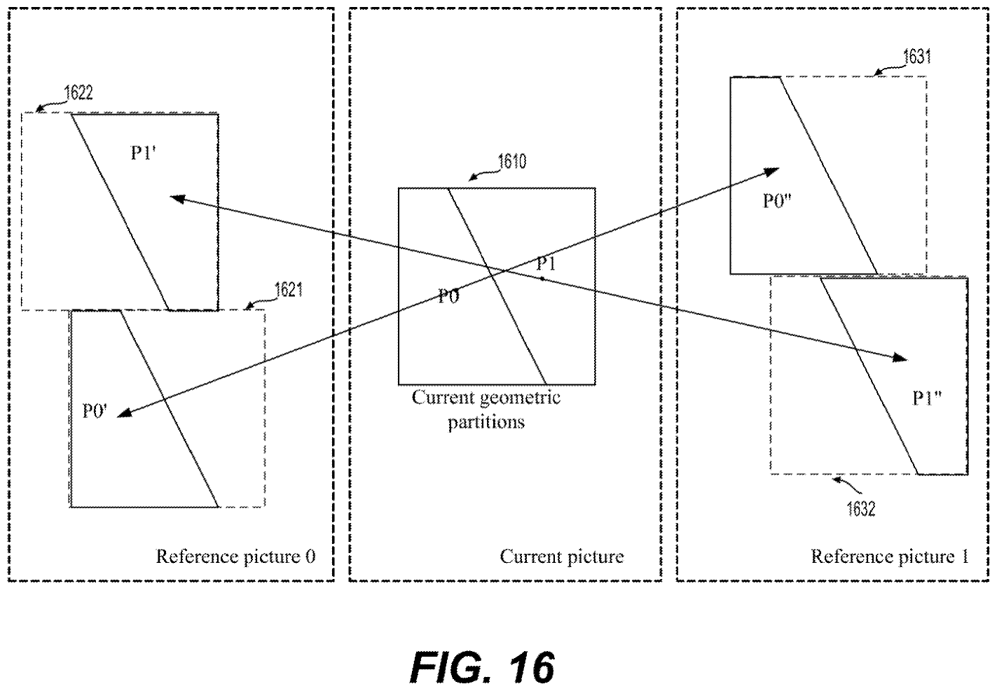

FIG. 16 shows a block (1610) in the GPM in some examples. The block (1610) is partitioned by a partition edge into a first partition P0 and a second partition P1. In some examples, DMVR is applied to one or both of the first partition P0 and the second partition P1. In some examples, respective DMVR can be applied separately for the first partition P0 and the second partition P1. In the FIG. 16 example, to apply the DMVR on the first partition P0, a forward reference region P0′ in the reference picture 0, and a backward reference region P0″ in the reference picture 1, that are have the same geometric partition shape as the first partition P0 are determined based on a refinement value on top of the motion vector, the DMVR matching cost associated with the refinement value on top of the motion vector can be calculated, for example, using sum of absolute difference (SAD) between the forward reference region P0′ and the backward reference region P0″. Similarly, in the FIG. 16 example, to apply the DMVR on the second partition P1, a forward reference region P1′ in the reference picture 0, and a backward reference region P1″ in the reference picture 1, that are have the same geometric partition shape as the second partition P1 are determined based on a refinement value on top of the motion vector, the DMVR matching cost associated with the refinement value on top of the motion vector can be calculated, for example, using sum of absolute difference (SAD) between the forward reference region P1′ and the backward reference region P1″.

In some embodiments, the block level DMVR refinement for each partition may be done based on the partition's MV value but the bilateral matching cost (also referred to as DMVR matching cost) may be calculated based on the full block area before splitting. In the FIG. 16 example, to apply the DMVR on the first partition P0, the DMVR matching cost associated with a refinement value on top of the motion vector can be calculated, for example, using sum of absolute difference (SAD) between a first reference block (1621) and a second reference block (1631). Similarly, in the FIG. 16 example, to apply the DMVR on the second partition P1, the DMVR matching cost associated with a refinement value on top of the motion vector can be calculated, for example, using sum of absolute difference (SAD) between a first reference block (1622) and a second reference block (1632).

In some embodiments, subblock DMVR may be further applied to further refine subblock motion vectors for a geometric partition. In some examples, when a subblock is split by the partition boundary (also referred to as partition edge) into subblock partitions, the DMVR process for a subblock partition may be based on the samples within the subblock partition. For example, the DMVR matching cost associated with the subblock partition is calculated based on the samples in the subblock partition.

In some embodiments, when a subblock is split by the partition boundary into subblock partitions, the DMVR process for a subblock partition may still be based on the subblock size according to the setting of subblock size for DMVR, for example 8×8 luma samples or 16×16 luma samples. For example, the DMVR matching cost associated with the subblock partition is calculated based on the samples in the subblock.

In some embodiments, DMVR is only applied when only one geometric partition is coded as inter prediction and the other one or more geometric partitions is(are) coded as intra prediction mode.

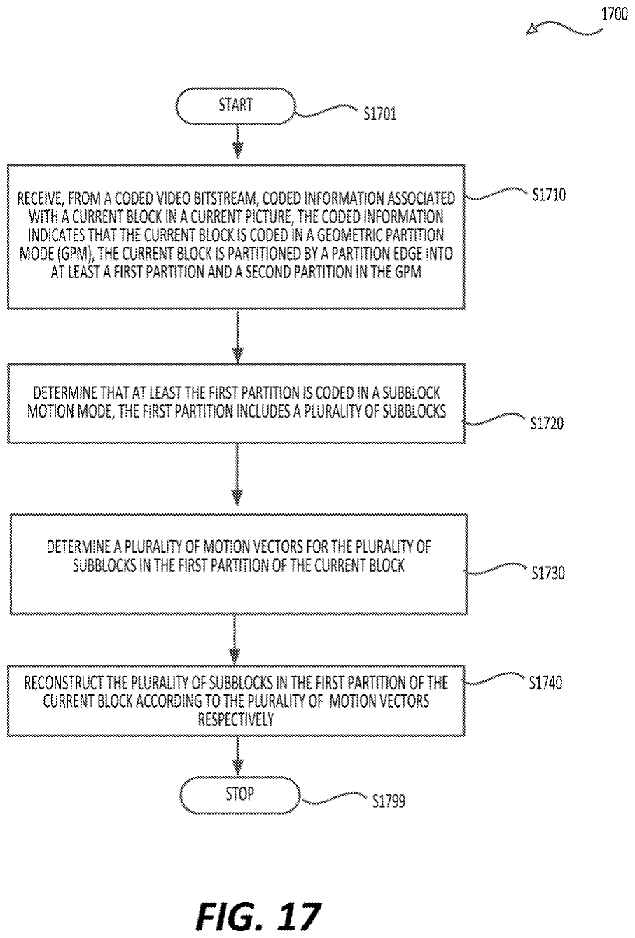

FIG. 17 shows a flow chart outlining a process (1700) according to an embodiment of the disclosure. The process (1700) can be used in a video decoder. In various embodiments, the process (1700) is executed by processing circuitry, such as the processing circuitry that performs functions of the video decoder (110), the processing circuitry that performs functions of the video decoder (210), and the like. In some embodiments, the process (1700) is implemented in software instructions, thus when the processing circuitry executes the software instructions, the processing circuitry performs the process (1700). The process starts at (S1701) and proceeds to (S1710).

At (S1710), from a coded video bitstream, coded information associated with a current block in a current picture is received. The coded information indicates that the current block is coded in a geometric partition mode (GPM). The current block is partitioned into at least a first partition and a second partition in the GPM by a partition edge.

At (S1720), at least the first partition being coded in a subblock motion mode is determined. The first partition includes a plurality of subblocks.

At (S1730), a plurality of motion vectors for the plurality of subblocks in the first partition of the current block are determined.

At (S1740), the plurality of subblocks in the first partition of the current block are reconstructed according to the plurality of motion vectors respectively.

In some examples, the subblock motion mode includes at least one of an affine prediction mode, a subblock based temporal motion vector prediction (SbTMVP), and a subblock based decoder side motion vector refinement (DMVR).

In some examples, in response to the current block in the GPM, a flag is decoded from the coded video bitstream, the flag indicates that both of the first partition and the second partition are in the subblock motion mode.

In some examples, in response to the first partition in the merge mode, a flag is decoded from the coded video bitstream, and the flag indicates whether the first partition is in a regular merge mode or a subblock based merge mode.

In some examples, in response to the first partition in the AMVP mode, a flag is decoded from the coded video bitstream, and the flag indicates whether the first partition is in a regular AMVP mode or an affine AMVP mode.

According to an aspect of the disclosure, the subblock motion mode is an affine mode. In some examples, the first partition and the second partition are coded in the affine mode. A first affine model for the first partition and a second affine model for the second partition are determined. The first partition of the current block is reconstructed according to the first affine model and the second partition of the current block is reconstructed according to the second affine model. The first affine model and the second affine model have different parameter values.

In some examples, the partition edge intersects with a top block boundary of the current block and does not intersect with a left block boundary of the current block. First control points for the first partition are located at a top-left corner, a top-right corner and a bottom-left corner of the first partition, and second control points for the second partition are located at a top-left corner, a top-right corner and a bottom-left corner of the second partition.

In some examples, the partition edge intersects with a left block boundary of the current block and does not intersect with a top block boundary of the current block. First control points for the first partition are located at a top-left corner, and a bottom-left corner of the first partition, and second control points for the second partition are located at a top-left corner, a top-right corner and a bottom-left corner of the second partition.

In some examples, the partition edge intersects with both a left block boundary of the current block and a top block boundary of the current block. First control points for the first partition are located at a top-left corner, a top-right corner and a bottom-left corner of the first partition, and second control points for the second partition are located at a top-left corner, a top-right corner and a bottom-left corner of the second partition.

In some examples, the subblock motion mode is an affine mode, the partition edge intersects none of a left block boundary of the current block and a top block boundary of the current block. First control points for the first partition are located at a top-left corner, a top-right corner and a bottom-left corner of the first partition, and the affine mode is not allowed for the second partition.

In some examples, the subblock motion mode is an affine mode. A first affine model for the first partition, and a second affine model for the second partition are derived based on control points of the current block, the first affine model is different from the second affine model.

In an example, control point motion vectors for the first partition are derived from an affine model of a first affine merge candidate of the current block, and control point motion vectors for the second partition are derived from an affine model of a second affine merge candidate of the current block.

In some examples, a control point motion vector at a corner of the first partition is determined from one of a plurality of translational motion vector candidates at the corner. In an example, the plurality of translational motion vector candidates can be motion vectors associated with spatial neighboring blocks. In another example, the plurality of translation motion vector candidates can be motion vectors associated with temporal neighboring blocks.

According to an aspect of the disclosure, the subblock motion mode is a subblock based temporal motion vector prediction (SbTMVP). In some embodiments, in a collocated picture of the current picture, a reference geometric partition is determined for the first partition. The reference geometric partition has a same shape as the first partition. A plurality of subblock motions of the reference geometric partition can be applied to the plurality of subblocks of the first partition.

In an example, a displacement vector that points to the reference geometric partition is determined from a motion vector of a neighboring block of the current block.

In another example, a displacement vector that points to the reference geometric partition is determined based on a motion vector of a neighboring block of the current block and a motion vector difference. The motion vector difference can be decoded from the coded video bitstream or can be derived using template matching.

In some examples, DMVR can be applied on the first partition. For example, for a motion vector refinement on a motion vector of the first partition, a first reference region in a first reference picture is determined, the first reference region has a same shape as the first partition. A second reference region in a second reference picture is determined, the second reference region has the same shape as the first partition. A matching cost associated with the motion vector refinement is calculated using the first reference region and the second reference region. The decoder side motion vector refinement is performed according to the matching cost associated with the motion vector refinement.

In another example, for a motion vector refinement on a motion vector of the first partition, a first reference block in a first reference picture is determined, and the first reference block has a same shape as the current block. A second reference block in a second reference picture is also determined, the second reference block has the same shape as the current block. A matching cost associated with the motion vector refinement is calculated using the first reference block and the second reference block. A decoder side motion vector refinement is performed according to the matching cost associated with the motion vector refinement.

In some examples, the subblock motion mode is a subblock based decoder side motion vector refinement (DMVR), the plurality of motion vectors for the plurality of subblocks in the first partition of the current block can be respectively refined using the subblock based DMVR.

Then, the process proceeds to (S1799) and terminates.

The process (1700) can be suitably adapted. Step(s) in the process (1700) can be modified and/or omitted. Additional step(s) can be added. Any suitable order of implementation can be used.

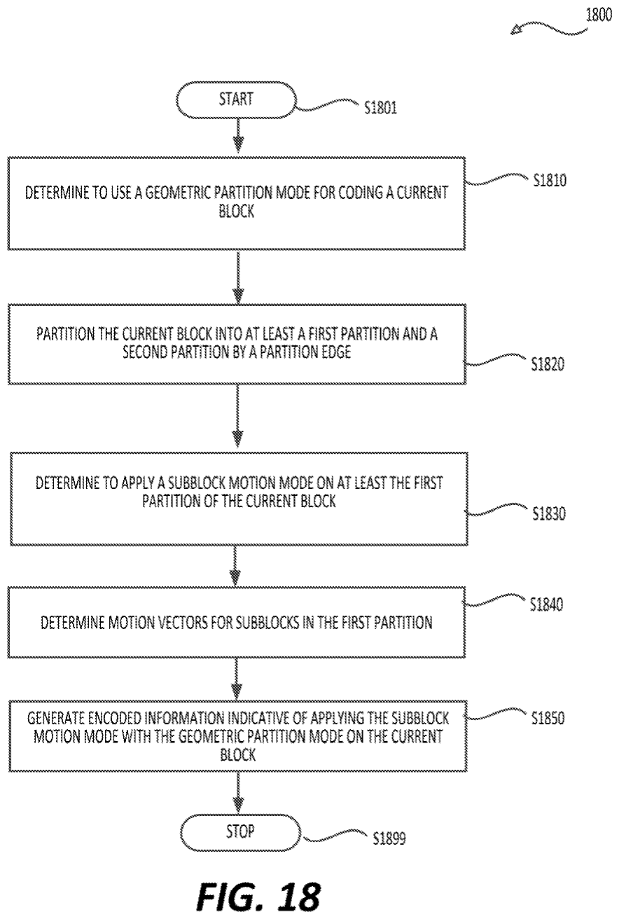

FIG. 18 shows a flow chart outlining a process (1800) according to an embodiment of the disclosure. The process (1800) can be used in a video encoder. In various embodiments, the process (1800) is executed by processing circuitry, such as the processing circuitry that performs functions of the video encoder (103), the processing circuitry that performs functions of the video encoder (303), and the like. In some embodiments, the process (1800) is implemented in software instructions, thus when the processing circuitry executes the software instructions, the processing circuitry performs the process (1800). The process starts at (S1801) and proceeds to (S1810).

At (S1810), to use a geometric partition mode for coding a current block is determined.

At (S1820), the current block is partition into at least a first partition and a second partition by a partition edge.

At (S1830), to apply a subblock motion mode on at least the first partition of the current block is determined.

At (S1840), motion vectors for subblocks in the first partition are determined. In some examples, the motion vectors for the subblocks in the first partition are used to reconstruct the first partition.

At (S1850), encoded information indicative of applying the subblock motion mode with the geometric partition mode on the current block is generated and included in a coded video bitstream.

In some examples, the subblock motion mode includes at least one of an affine prediction mode, a subblock based temporal motion vector prediction (SbTMVP), and a subblock based decoder side motion vector refinement (DMVR).

In some examples, when the current block is in the GPM, a flag is encoded into the coded video bitstream, the flag indicates that both of the first partition and the second partition are in the subblock motion mode.

In some examples, when the first partition is in the merge mode, a flag is encoded into the coded video bitstream, and the flag indicates whether the first partition is in a regular merge mode or a subblock based merge mode.

In some examples, when the first partition in the AMVP mode, a flag is encoded into the coded video bitstream, and the flag indicates whether the first partition is in a regular AMVP mode or an affine AMVP mode.

According to an aspect of the disclosure, the subblock motion mode is an affine mode. In some examples, the first partition and the second partition are coded in the affine mode. A first affine model for the first partition and a second affine model for the second partition are determined. The first partition of the current block is reconstructed according to the first affine model and the second partition of the current block is reconstructed according to the second affine model. The first affine model and the second affine model have different parameter values.

In some examples, the partition edge intersects with a top block boundary of the current block and does not intersect with a left block boundary of the current block. First control points for the first partition are located at a top-left corner, a top-right corner and a bottom-left corner of the first partition, and second control points for the second partition are located at a top-left corner, a top-right corner and a bottom-left corner of the second partition.

In some examples, the partition edge intersects with a left block boundary of the current block and does not intersect with a top block boundary of the current block. First control points for the first partition are located at a top-left corner, and a bottom-left corner of the first partition, and second control points for the second partition are located at a top-left corner, a top-right corner and a bottom-left corner of the second partition.

In some examples, the partition edge intersects with both a left block boundary of the current block and a top block boundary of the current block. First control points for the first partition are located at a top-left corner, a top-right corner and a bottom-left corner of the first partition, and second control points for the second partition are located at a top-left corner, a top-right corner and a bottom-left corner of the second partition.

In some examples, the subblock motion mode is an affine mode, the partition edge intersects none of a left block boundary of the current block and a top block boundary of the current block. First control points for the first partition are located at a top-left corner, a top-right corner and a bottom-left corner of the first partition, and the affine mode is not allowed for the second partition.

In some examples, the subblock motion mode is an affine mode. A first affine model for the first partition, and a second affine model for the second partition are derived based on control points of the current block, the first affine model is different from the second affine model.

In an example, control point motion vectors for the first partition are derived from an affine model of a first affine merge candidate of the current block, and control point motion vectors for the second partition are derived from an affine model of a second affine merge candidate of the current block.

In some examples, a control point motion vector at a corner of the first partition is determined from one of a plurality of translational motion vector candidates at the corner. In an example, the plurality of translational motion vector candidates can be motion vectors associated with spatial neighboring blocks. In another example, the plurality of translation motion vector candidates can be motion vectors associated with temporal neighboring blocks.

According to an aspect of the disclosure, the subblock motion mode is a subblock based temporal motion vector prediction (SbTMVP). In some embodiments, in a collocated picture of the current picture, a reference geometric partition is determined for the first partition. The reference geometric partition has a same shape as the first partition. Subblock motions of the reference geometric partition can be applied to the subblocks of the first partition as the motion vectors of the subblocks.

In an example, a displacement vector that points to the reference geometric partition is determined from a motion vector of a neighboring block of the current block.

In another example, a displacement vector that points to the reference geometric partition is determined based on a motion vector of a neighboring block of the current block and a motion vector difference. The motion vector difference can be signaled in the coded video bitstream or can be derived using template matching.

In some examples, DMVR can be applied on the first partition for motion vector refinement. For example, for a motion vector refinement (value) on a motion vector of the first partition, a first reference region in a first reference picture is determined, the first reference region has a same shape as the first partition. A second reference region in a second reference picture is determined, the second reference region has the same shape as the first partition. A matching cost associated with the motion vector refinement is calculated using the first reference region and the second reference region. The decoder side motion vector refinement is performed according to the matching cost associated with the motion vector refinement.

In another example, for a motion vector refinement (value) on a motion vector of the first partition, a first reference block in a first reference picture is determined, and the first reference block has a same shape as the current block. A second reference block in a second reference picture is also determined, the second reference block has the same shape as the current block. A matching cost associated with the motion vector refinement is calculated using the first reference block and the second reference block. A decoder side motion vector refinement is performed according to the matching cost associated with the motion vector refinement.

In some examples, the subblock motion mode is a subblock based decoder side motion vector refinement (DMVR), the motion vectors for the subblocks in the first partition of the current block can be respectively refined using the subblock based DMVR.

Then, the process proceeds to (S1899) and terminates.

The process (1800) can be suitably adapted. Step(s) in the process (1800) can be modified and/or omitted. Additional step(s) can be added. Any suitable order of implementation can be used.

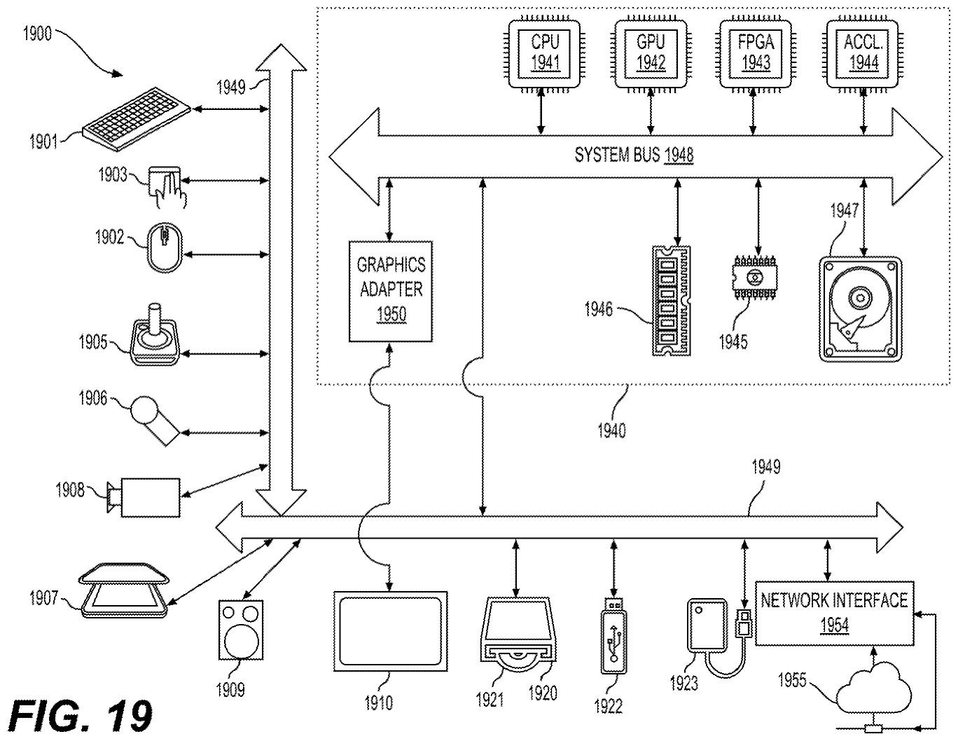

The techniques described above, can be implemented as computer software using computer-readable instructions and physically stored in one or more computer-readable media. For example, FIG. 19 shows a computer system (1900) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 19 for computer system (1900) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1900).

Computer system (1900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1901), mouse (1902), trackpad (1903), touch screen (1910), data-glove (not shown), joystick (1905), microphone (1906), scanner (1907), camera (1908).

Computer system (1900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1910), data-glove (not shown), or joystick (1905), but there can also be tactile feedback devices that do not serve as input devices), audio output devices (such as: speakers (1909), headphones (not depicted)), visual output devices (such as screens (1910) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1900) can also include human accessible storage devices and their associated media such as optical media including CD/DVD ROM/RW (1920) with CD/DVD or the like media (1921), thumb-drive (1922), removable hard drive or solid state drive (1923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1900) can also include an interface (1954) to one or more communication networks (1955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1949) (such as, for example USB ports of the computer system (1900)); others are commonly integrated into the core of the computer system (1900) by attachment to a system bus as described below (for example Ethernet interface into a PC computer system or cellular network interface into a smartphone computer system). Using any of these networks, computer system (1900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1940) of the computer system (1900).

The core (1940) can include one or more Central Processing Units (CPU) (1941), Graphics Processing Units (GPU) (1942), specialized programmable processing units in the form of Field Programmable Gate Areas (FPGA) (1943), hardware accelerators for certain tasks (1944), graphics adapters (1950), and so forth. These devices, along with Read-only memory (ROM) (1945), Random-access memory (1946), internal mass storage such as internal non-user accessible hard drives, SSDs, and the like (1947), may be connected through a system bus (1948). In some computer systems, the system bus (1948) can be accessible in the form of one or more physical plugs to enable extensions by additional CPUs, GPU, and the like. The peripheral devices can be attached either directly to the core's system bus (1948), or through a peripheral bus (1949). In an example, the screen (1910) can be connected to the graphics adapter (1950). Architectures for a peripheral bus include PCI, USB, and the like.

CPUs (1941), GPUs (1942), FPGAs (1943), and accelerators (1944) can execute certain instructions that, in combination, can make up the aforementioned computer code. That computer code can be stored in ROM (1945) or RAM (1946). Transitional data can be also be stored in RAM (1946), whereas permanent data can be stored for example, in the internal mass storage (1947). Fast storage and retrieve to any of the memory devices can be enabled through the use of cache memory, that can be closely associated with one or more CPU (1941), GPU (1942), mass storage (1947), ROM (1945), RAM (1946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1900), and specifically the core (1940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1940) that are of non-transitory nature, such as core-internal mass storage (1947) or ROM (1945). The software implementing various embodiments of the present disclosure can be stored in such devices and executed by core (1940). A computer-readable medium can include one or more memory devices or chips, according to particular needs. The software can cause the core (1940) and specifically the processors therein (including CPU, GPU, FPGA, and the like) to execute particular processes or particular parts of particular processes described herein, including defining data structures stored in RAM (1946) and modifying such data structures according to the processes defined by the software. In addition or as an alternative, the computer system can provide functionality as a result of logic hardwired or otherwise embodied in a circuit (for example: accelerator (1944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding, comprising:
receiving, from a coded video bitstream, coded information associated with a current block in a current picture, the coded information indicating that the current block is coded in a geometric partition mode (GPM), the current block being partitioned into at least a first partition and a second partition in the GPM by a partition edge;
determining that at least the first partition is coded in a subblock motion mode, the first partition comprising a plurality of subblocks;
determining a plurality of motion vectors for the plurality of subblocks in the first partition of the current block; and
reconstructing the plurality of subblocks in the first partition of the current block according to the plurality of motion vectors respectively.

2. The method of claim 1, wherein the subblock motion mode comprises at least one of an affine prediction mode, a subblock based temporal motion vector prediction (SbTMVP), and a subblock based decoder side motion vector refinement (DMVR).

3. The method of claim 1, wherein the determining that at least the first partition is coded in the subblock motion mode further comprises:
decoding, in response to the current block in the GPM, a flag from the coded video bitstream, the flag indicating that both of the first partition and the second partition are in the subblock motion mode.

4. The method of claim 1, wherein the determining that at least the first partition is coded in the subblock motion mode further comprises:
determining that the first partition is coded in a merge mode; and
in response to the first partition in the merge mode, decoding a flag from the coded video bitstream, the flag indicating whether the first partition is in a regular merge mode or a subblock based merge mode.

5. The method of claim 1, wherein the determining that at least the first partition is coded in the subblock motion mode further comprises:
determining that the first partition is coded in an advanced motion vector prediction (AMVP) mode; and
in response to the first partition in the AMVP mode, decoding a flag from the coded video bitstream, the flag indicating whether the first partition is in a regular AMVP mode or an affine AMVP mode.

6. The method of claim 1, wherein the subblock motion mode is an affine mode, and the method comprises:
determining that the first partition and the second partition are coded in the affine mode;
determining a first affine model for the first partition and a second affine model for the second partition; and
reconstructing the first partition of the current block according to the first affine model and the second partition of the current block according to the second affine model.

7. The method of claim 6, wherein the partition edge intersects with a top block boundary of the current block and does not intersect with a left block boundary of the current block, first control points for the first partition are located at a top-left corner, a top-right corner and a bottom-left corner of the first partition, and second control points for the second partition are located at a top-left corner, a top-right corner and a bottom-left corner of the second partition.

8. The method of claim 6, wherein the partition edge intersects with a left block boundary of the current block and does not intersect with a top block boundary of the current block, first control points for the first partition are located at a top-left corner, and a bottom-left corner of the first partition, and second control points for the second partition are located at a top-left corner, a top-right corner and a bottom-left corner of the second partition.

9. The method of claim 6, wherein the partition edge intersects with both a left block boundary of the current block and a top block boundary of the current block, first control points for the first partition are located at a top-left corner, a top-right corner and a bottom-left corner of the first partition, and second control points for the second partition are located at a top-left corner, a top-right corner and a bottom-left corner of the second partition.

10. The method of claim 1, wherein the subblock motion mode is an affine mode, the partition edge intersects none of a left block boundary of the current block and a top block boundary of the current block, first control points for the first partition are located at a top-left corner, a top-right corner and a bottom-left corner of the first partition, and the affine mode is not allowed for the second partition.

11. The method of claim 1, wherein the subblock motion mode is an affine mode, the method further comprises:
deriving a first affine model for the first partition, and a second affine model for the second partition based on control points of the current block, the first affine model being different from the second affine model.

12. The method of claim 11, further comprising:
deriving control point motion vectors for the first partition from an affine model of a first affine merge candidate of the current block; and
deriving control point motion vectors for the second partition from an affine model of a second affine merge candidate of the current block.

13. The method of claim 11, further comprising:
determining a control point motion vector at a corner of the first partition from one of a plurality of translational motion vector candidates at the corner, the plurality of translational motion vector candidates comprising at least one of motion vectors associated with spatial neighboring blocks, motion vectors associated with temporal neighboring blocks.

14. The method of claim 1, wherein the subblock motion mode is a subblock based temporal motion vector prediction (SbTMVP), and the determining the plurality of motion vectors for the plurality of subblocks in the first partition further comprises:
determining, in a collocated picture of the current picture, a reference geometric partition for the first partition, the reference geometric partition having a same shape as the first partition; and
applying a plurality of subblock motions of the reference geometric partition to the plurality of subblocks of the first partition.

15. The method of claim 14, further comprising:
determining a displacement vector that points to the reference geometric partition from a motion vector of a neighboring block of the current block.

16. The method of claim 14, further comprising:
determining a displacement vector that points to the reference geometric partition based on a motion vector of a neighboring block of the current block and a motion vector difference.

17. The method of claim 16, further comprising at least one of:
decoding the motion vector difference from the coded video bitstream; or
deriving the motion vector difference using template matching.

18. The method of claim 1, further comprising:
for a motion vector refinement on a motion vector of the first partition,
determining a first reference region in a first reference picture, the first reference region having a same shape as the first partition;
determining a second reference region in a second reference picture, the second reference region having the same shape as the first partition;
calculating a matching cost associated with the motion vector refinement using the first reference region and the second reference region; and
performing a decoder side motion vector refinement according to the matching cost associated with the motion vector refinement.

19. The method of claim 1, further comprising:
for a motion vector refinement on a motion vector of the first partition,
determining a first reference block in a first reference picture, the first reference block having a same shape as the current block;
determining a second reference block in a second reference picture, the second reference block having the same shape as the current block;
calculating a matching cost associated with the motion vector refinement using the first reference block and the second reference block; and
performing a decoder side motion vector refinement according to the matching cost associated with the motion vector refinement.

20. The method of claim 1, wherein the subblock motion mode is a subblock based decoder side motion vector refinement (DMVR), and method further comprises:
refining the plurality of motion vectors for the plurality of subblocks in the first partition of the current block using the subblock based DMVR.
